(19) United States
(12) Patent Application Publication
(10) Pub. No.: US 2008/0231572 A1
(43) Pub. Date: Sep. 25, 2008

(54) Liquid crystal display and driving method thereof

(75) Inventor: De-Ching Shie, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/077,385

(22) Filed: Mar. 19, 2008

(30) Foreign Application Priority Data
Mar. 19, 2007 (TW) 96109264

(51) Int. Cl. G09G 3/36

(52) U.S. Cl. 345/87

(57) ABSTRACT

An exemplary LCD (20) includes a first substrate (21), a second substrate (22) parallel to the first substrate, and a liquid crystal layer (23) sandwiched between the first and second substrates. The first substrate includes a number of separated common electrodes (25). The second substrate includes a number of gate lines (221) parallel to each other, and a number of data lines (222) perpendicular to the gate lines. The number of common electrodes correspond to the number of data lines. The LCD can realize a dot inversion driving method in the case of alternating driving method for the common voltage.

### FIELD OF THE INVENTION

The present invention relates to liquid crystal displays (LCDs) and driving methods thereof, and particularly to an LCD which has strip-shaped common electrodes and a dot inversion mode driving method of the LCD.

### GENERAL BACKGROUND

A liquid crystal display utilizes liquid crystal molecules to control light transmission in each pixel. The liquid crystal molecules are driven according to external video signals received by the liquid crystal display. A conventional liquid crystal display generally employs a selected one of a frame inversion mode, a row inversion mode, a column inversion mode, or a dot inversion mode to drive the liquid crystal molecules. Each of these driving inversion modes can protect the liquid crystal molecules from decay or damage.

Referring to FIG. 6, a typical LCD panel 10 includes a first substrate 11, a second substrate 12 opposite to the first substrate 11, and a liquid crystal layer 13 sandwiched between the two substrates 11, 12. A common electrode 15 is formed on a surface of the first substrate 11 adjacent to the liquid crystal layer 13. The common electrode 15 is generally plate-shaped.

Referring to FIG. 7, the second substrate 12 includes a plurality of gate lines 121 parallel to each other, a plurality of data lines 122, a plurality of thin film transistors (TFTs) 123, and a plurality of pixel electrodes 124. The plurality of data lines 122 are parallel to each other, and are perpendicular to the plurality of gate lines 121. Each TFT 123 is provided in the vicinity of a respective point of intersections of the gate lines 121 and the data lines 122. The plurality of gate lines 121 and the plurality of data lines 122 define a plurality of pixel units (not labeled), which are minimum display units of the LCD panel 10. Each pixel unit includes one TFT 123, one pixel electrode 124, the common electrode 15, and the liquid crystal layer 13 sandwiched between the pixel electrode 124 and the common electrode 15.

A difference value between a gradation voltage and a common voltage is defined as a display voltage. If the display voltage is greater than 0, the display voltage of the pixel unit has a positive polarity. If the display voltage is less than 0, the display voltage of the pixel unit has a negative polarity.

FIG. 8 is a schematic explanatory view illustrating the polarities of the display voltages of the pixel units in the case there a frame inversion mode is employed. In a frame, the display voltages of all the pixel units have the same polarity, e.g., a positive polarity. In a next frame, the display voltages of all the pixel units have the same negative polarity. This frame inversion mode driving method is rarely used because a flicker problem and a crosstalk problem occur, and deteriorate the display performance of the LCD panel 10.

FIG. 9 is a schematic explanatory view illustrating the polarities of the display voltages of the pixel units in the case there a row inversion mode is employed. In a frame, the display voltages of all the pixel units in a same row have the same polarity, e.g., a positive polarity, and the display voltages of all the pixel units in an adjacent row have the same negative polarity. In a next frame, the display voltages of all the pixel units have reversed polarities. Compared to the frame inversion mode driving method, the row inversion mode driving method has improved display performance. However, the crosstalk in the direction along the gate lines 121 is still a problem.

FIG. 10 is a schematic explanatory view illustrating the polarities of the display voltages of the pixel units in the case there a column inversion mode is employed. In a frame, the display voltages of all the pixel units in a same column have a same polarity, e.g., a positive polarity, and the display voltages of all the pixel units in an adjacent column have the same negative polarity. In a next frame, the display voltages of all the pixel units have reversed polarities. Compared to the frame inversion mode driving method, the column inversion mode driving method has improved display performance. However, the crosstalk in the direction along the data lines 122 is still a problem.

FIG. 11 is a schematic explanatory view illustrating the polarities of the display voltages of the pixel units in the case there a dot inversion mode is employed. In a frame, the display voltage of each pixel unit has a reversed polarity relative to all adjacent pixel units. In a next frame, the display voltages of all the pixel units have reversed polarities. The dot inversion mode driving method has satisfactory display performance due to preventing the flicker problem and the crosstalk problem.

Although there are four inversion mode driving modes, a suitable inversion driving mode needs to be determined according to a selected driving method for the common voltage cooperatively. When the driving method for the common voltage adopts a direct driving method, the common voltage is constant. When the driving method for the common voltage adopts an alternating driving method, the common voltage is alternative.

If the common voltage is constant, any one of the four inversion driving modes can be realized. Referring to FIG. 12, waveforms of gradation voltages and a constant common voltage are shown in the case that the direct driving method is adopted. A maximum 10 volts display voltage as well as the 10 volts common voltage V_{com1} is taken as an example. To realize the inversion driving method, a minimum gradation voltage V_{gl1} needs to be less than or equal to 0 volt, and a maximum gradation voltage V_{gh1} needs to be greater than or equal to 20 volts. That is, a data driver for driving the data lines 122 needs to output gradation voltages in the range from 0 to 20 volts. This means that the data driver needs a high performance, thus generally has a high cost.

Referring to FIG. 13, waveforms of gradation voltages and an alternating common voltage are shown in the case that the alternating driving method is adopted. A maximum 10 volts display voltage is taken as an example. The alternating common voltage V_{com2} has a 10 volt high level voltage and a 0 volt low level voltage. To realize the inversion driving method, both a minimum gradation voltage V_{gl2} and a maximum gradation voltage V_{gh2} only need to be in the range from 0 to 10 volts. That is, a data driver for driving the data lines 122 can output a voltage in the range from 0 to 10 volts. Compared to the constant common voltage driving method as shown in FIG. 12, performance demand of the data driver for this driving method decreases greatly, thus the data driver generally has a low cost. Therefore, the alternating driving method for the common voltage is widely used.

However, the dot inversion driving method can not be realized when the alternating driving method is employed. For example, when the alternating common voltage is at the high level voltage 10 volts, the LCD panel 10 cannot display an image with a positive polarity in a row because the maximum gradation voltages provided by the data driver is less than 10 volts. For the same reason, the column inversion driving method can not be realized either.

What is needed, therefore, is an LCD that can overcome the above-described deficiencies. What is also needed is a method for driving the LCD.

### SUMMARY

In one preferred embodiment, an LCD includes a first substrate, a second substrate parallel to the first substrate, and a liquid crystal layer sandwiched between the first and second substrates. The first substrate includes a plurality of separated common electrodes. The second substrate includes a plurality of gate lines parallel to each other, and a plurality of data lines perpendicular to the gate lines. The plurality of common electrodes correspond to the plurality of data lines.

Other novel features and advantages of the present LCD and method for driving the LCD will become more apparent from the following detailed description when taken in conjunction with the accompanying drawings. In the drawings, all the views are schematic.

### BRIEF DESCRIPTION OF THE DRAWINGS

FIG. 1 is a side view of an LCD according to an exemplary embodiment of the present invention, the LCD including a first substrate and a second substrate.

FIG. 2 is essentially an abbreviated circuit diagram of the second substrate of FIG. 1.

FIG. 3 is a plan view of the first substrate of FIG. 1.

FIG. 4 is a waveform diagram of driving signals of the LCD.

FIG. 5 is an explanatory view illustrating polarities of display voltages of pixel units in a dot inversion driving method.

FIG. 6 is a side cross-sectional view of a conventional LCD, the LCD including a first substrate and a second substrate.

FIG. 7 is essentially an abbreviated circuit diagram of the second substrate of FIG. 6.

FIG. 8 to FIG. 11 are explanatory views illustrating the polarities of the display voltages of pixel units in four inversion driving methods for the LCD of FIG. 6, the methods including a frame inversion driving method, a row inversion driving method, a column inversion driving method, and a dot inversion driving method.

FIG. 12 is a waveform diagram showing gradation voltages and a constant common voltage in a direct driving method for the common voltage.

FIG. 13 is a waveform diagram showing gradation voltages and an alternating common voltage in an alternating driving method for the common voltage.

### DETAILED DESCRIPTION OF PREFERRED EMBODIMENTS

Reference will now be made to the drawing figures to describe various embodiments of the present invention in detail.

Referring to FIG. 1, an LCD 20 according to an exemplary embodiment of the present invention is shown. The LCD 20 includes an LCD panel 28 and a backlight module 29 adjacent to the LCD panel 28 for providing planar backlight. The LCD panel 28 includes a first substrate 21, a second substrate 22 opposite and parallel to the first substrate 21, and a liquid crystal layer 23 sandwiched between the two substrates 21, 22.

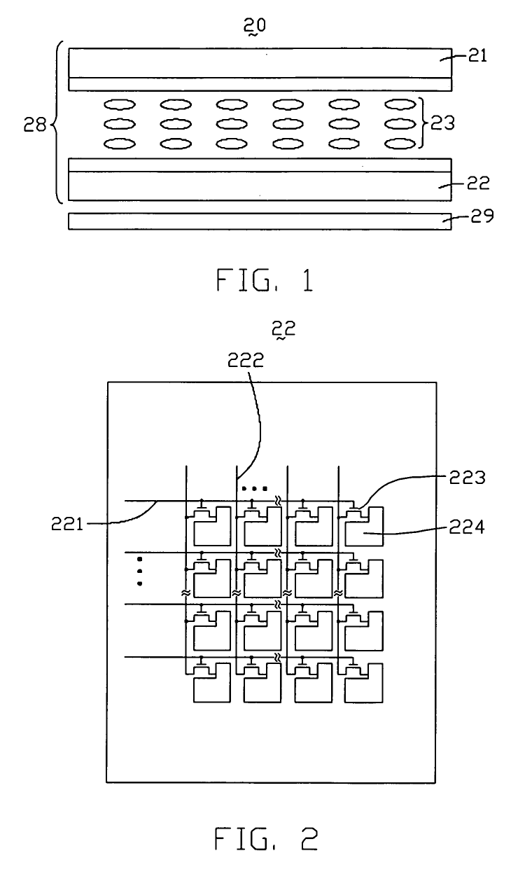

Referring to FIG. 2, the second substrate 22 includes a plurality of gate lines 221 parallel to each other, a plurality of data lines 222, a plurality of thin film transistors (TFTs) 223, and a plurality of pixel electrodes 224. The plurality of data lines 222 are parallel to each other, and are perpendicular to the plurality of gate lines 221. Each TFT 223 is provided in the vicinity of a respective point of intersections of the gate lines 221 and the data lines 222. The plurality of gate lines 221 and the plurality of data lines 222 define a plurality of pixel units (not labeled), which are minimum display units of the LCD panel 28. Each pixel unit includes a TFT 223, a pixel electrode 224, a common electrode 25, and the liquid crystal layer 23 sandwiched between the pixel electrode 224 and the common electrode 25.

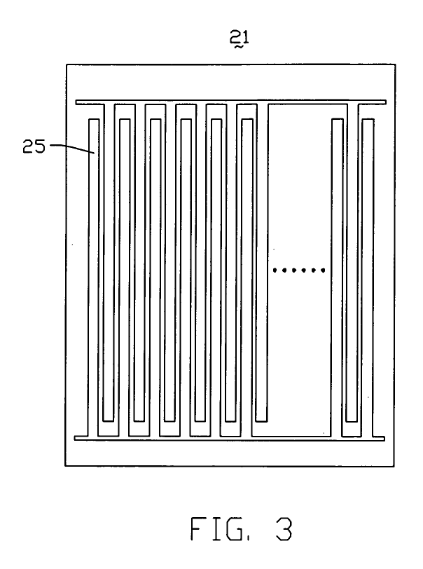

Referring to FIG. 3, the common electrodes 25 are formed on a surface of the first substrate 21 adjacent to the liquid crystal layer 23. Each of the common electrodes 25 has a strip shape. The common electrodes 25 are separated from each other. Moreover, the strip-shaped common electrodes 25 are parallel to the data lines 222 of the second substrate 22. Each common electrode 25 corresponds to a data line 222.

Each common electrode 25 includes a first end (not labeled) and a second end (not labeled). The first ends locate at one side of the second substrate 22, and the second ends locate at the opposite side of the second substrate 22. All the first ends of odd-numbered common electrodes 25 are electrically connected with each other, and all the second ends of even-numbered common electrodes 25 are electrically connected with each other.

FIG. 4 is an abbreviated timing chart illustrating operation of the LCD 20. Scanning signals G₁-G₂ₙ are applied to the scanning lines 221. Gradation voltages Vₙ are sequentially applied to the data lines 222. A first alternating common voltage V_{com1} and a second alternating common voltage V_{com2} are applied to the odd-numbered common electrodes 25 and the even-numbered common electrodes 25 respectively. Frame 1 and Frame 2 represent two adjacent, sequential frames. When the gate lines 221 are scanned, the gradation voltage Vₙ are applied to the pixel electrode 224 via the corresponding activated TFT 223.

The first common voltage V_{com1} has a reversed phase relative to the second common voltage V_{com2}. While the first common voltage is in a high level voltage, the second common voltage is in a low level voltage, and vice versa. Amplitudes of the first common voltage and the second common voltage are the same. Phases of the first common voltage and the second common voltage are reversed after a gate line 221 is scanned. Frequencies of the first common voltage and the second common voltage are the same as that of a scanning frequency of the gate lines 221, such as 60 Hz.

A difference value between the gradation voltage and the common voltage is defined as a display voltage. If the display voltage is greater than 0, the display voltage of the pixel unit has a positive polarity, and if the display voltage is less than 0, the display voltage of the pixel unit has a negative polarity.

A method for driving the LCD 20 is described as follow. Only two representative frames (frame 1 and frame 2) are taken as examples to describe the method, and other frames have similar operations.

During frame 1, the first common voltage V_{com1} is applied to the odd-numbered common electrodes 25, and the second common voltage V_{com2} is applied to the even-numbered common electrodes 25.

When a first gate line 221 is scanned, gradation voltages are applied to the pixel electrodes 224 in a first row via the corresponding TFTs 223. Values of the gradation voltages are in the range between the high level voltage and the low level voltage of the common voltage. At this moment, the odd-numbered common electrodes 25 are at the high level voltage, and the even-numbered common electrodes 25 are at the low level voltage. The pixel units corresponding to the odd-numbered common electrodes 25 have a negative polarity, and the pixel units corresponding to the even-numbered common electrodes 25 have a positive polarity. Thus, any two adjacent pixel units in the first row have reversed polarities relative to each other.

When a second gate line 221 is scanned, gradation voltages are applied to the pixel electrodes 224 in a second row via the corresponding TFTs 223. Values of the gradation voltages are in the range between the high level voltage and the low level voltage of the common voltage. At this moment, the common voltage of the odd-numbered common electrodes 25 is reversed to the low level voltage, and the common voltage of the even-numbered common electrodes 25 is reversed to the high level voltage. The pixel units corresponding to the odd-numbered common electrodes 25 have a positive polarity, and the pixel units corresponding to the even-numbered common electrodes 25 have a negative polarity. Thus, any two adjacent pixel units in the second row have reversed polarities relative to each other, and any two adjacent pixel units in the same column have reversed polarities.

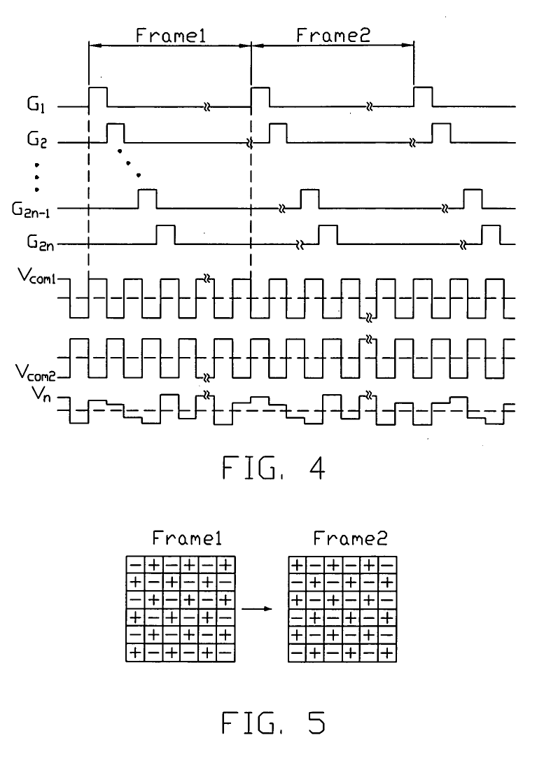

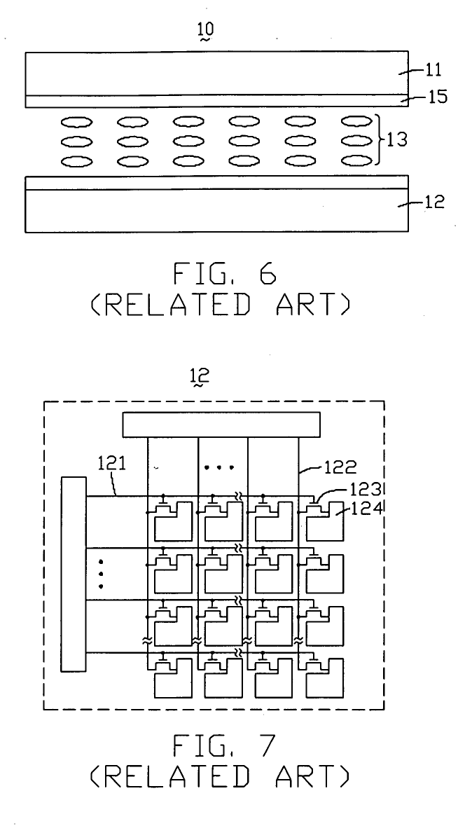

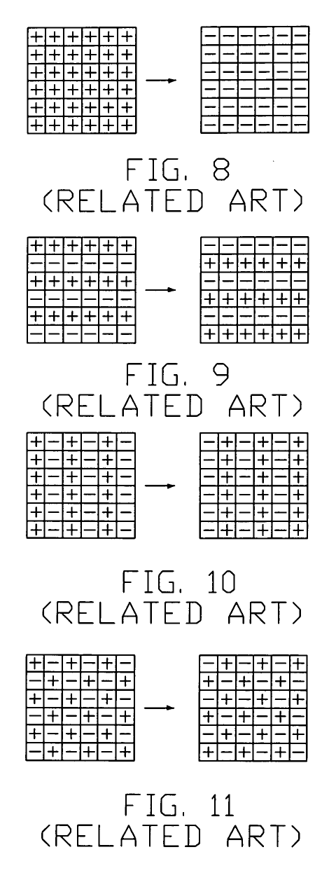

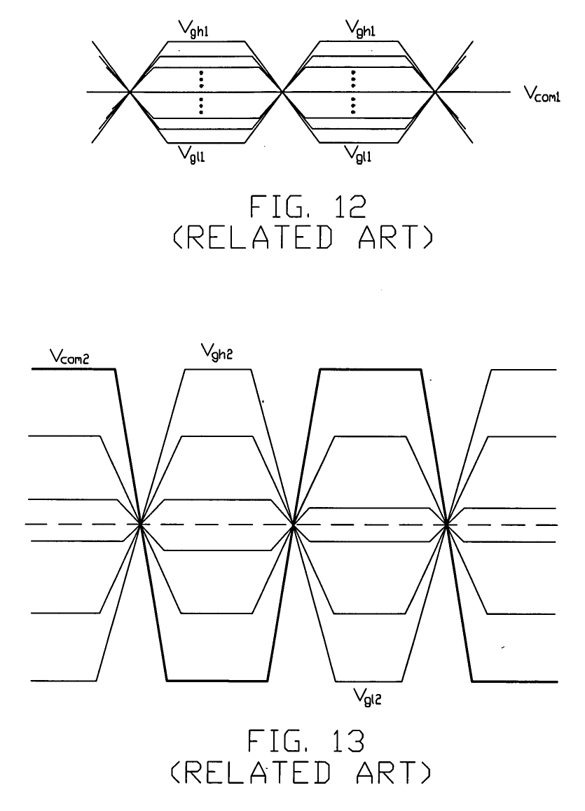

When a third gate line 221 is scanned, the operation is similar to that when the first gate line 221 is scanned. When the fourth gate line 221 is scanned, the operation is similar to that when the second gate line 221 is scanned. When other gate lines 221 are scanned, operations are repeated as above until the last gate line 221 is scanned. Thus, an image of frame 1 is displayed. The polarities of the pixel units are shown as frame 1 of FIG. 5.

During frame 2, the first common voltage V_{com1} is applied to the even-numbered common electrodes 25, and the second common voltage V_{com2} is applied to the odd-numbered common electrodes 25.

When a first gate line 221 is scanned, gradation voltages are applied to the pixel electrodes 224 in a first row via the corresponding TFTs 223. Values of the gradation voltages are in the range between the high level voltage and the low level voltage of the common voltage. At this moment, the even-numbered common electrodes 25 are at the high level voltage, and the odd-numbered common electrodes 25 are at the low level voltage. The pixel units corresponding to the odd-numbered common electrodes 25 have a positive polarity, and the pixel units corresponding to the even-numbered common electrodes 25 have a negative polarity. Thus, any two adjacent pixel units in the first row have reversed polarities. And the polarities of the pixel units in the first row of frame 2 are reversed relative to the corresponding pixel units in the first row of frame 1.

When a second gate line 221 is scanned, gradation voltages are applied to the pixel electrodes 224 in the second row via the corresponding TFTs 223. Values of the gradation voltages are in the range between the high level voltage and the low level voltage of the common voltage. At this moment, the common voltage of the odd-numbered common electrodes 25 is reversed to the high level voltage, and the common voltage of the even-numbered common electrodes 25 is reversed to the low level voltage. The pixel units corresponding to the odd-numbered common electrodes 25 have negative polarities, and the pixel units corresponding to the even-numbered common electrodes 25 have positive polarities. Thus, any two adjacent pixel units in the second row have a reversed polarity. And any two adjacent pixel units in a same column have reversed polarities relative to each other. Moreover, the polarities of the pixel units in the second row of frame 2 are reversed relative to the corresponding pixel units in the second row of frame 1.

When a third gate line 221 is scanned, the operation is similar to that when the first gate line 221 is scanned. When a fourth gate line 221 is scanned, the operation is similar to that when the second gate line 221 is scanned. When other gate lines 221 are scanned, operations are repeated as above until the last gate line 221 is scanned. Thus, a next image of frame 2 is displayed. The polarities of the pixel units are shown as frame 2 of FIG. 5.

According to the above description, polarities of all the pixel units of frame 1 are changed to reversed polarities in the frame 2. Thus, the LCD 20 realizes the dot inversion driving method in the case that the alternating driving method for the common voltage is adopted.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display (LCD), comprising:
a first substrate comprising a plurality of separated common electrodes;
a second substrate parallel to the first substrate, the second substrate comprising a plurality of gate lines parallel to each other, and a plurality of data lines perpendicular to the gate lines, the plurality of common electrodes corresponding to the plurality of data lines; and
a liquid crystal layer sandwiched between the first and second substrates.

2. The LCD as claimed in claim 1, wherein each of the common electrodes has a strip shape.

3. The LCD as claimed in claim 1, wherein each common electrode comprises a first end and a second end, the first ends of the odd-numbered common electrodes being electrically connected with each other, the second ends of the even-numbered common electrodes being electrically connected with each other.

4. The LCD as claimed in claim 1, wherein the second substrate further comprises a plurality of pixel units defined by a minimum area formed by the date lines and gate lines.

5. The LCD as claimed in claim 4, wherein each pixel unit comprises a thin film transistor (TFT) and a pixel electrode, the TFT being provided in the vicinity of a respective point of intersection of the data lines and gate lines.

6. A method for driving a liquid crystal display (LCD) of claim 1, the method comprising:
during one frame, providing a first alternating common voltage to the odd-numbered common electrodes, and providing a second alternating common voltage to the even-numbered common electrodes, the first alternating common voltage having a reversed phase relative to the second alternating common voltage, both the phases of the first and second alternating common voltages being reversed after one gate line being scanned;
during a next frame, providing the second alternating common voltage to the odd-numbered common electrodes, and providing the first alternating common voltage to the even-numbered common electrodes.

7. The method as claimed in claim 6, wherein gradation voltages are applied to the pixel electrodes via the corresponding TFTs when the gate lines are scanned.

8. The method as claimed in claim 6, wherein the first and second alternating common voltages both have a high level voltage and a low level voltage.

9. The method as claimed in claim 8, further comprising:
during the first frame, scanning the first gate line, applying the high level voltage to the odd-numbered common electrodes, applying the low level voltage to the even-numbered common electrodes, applying gradation voltages to the pixel electrodes, gradation voltages applied to the pixel electrodes corresponding to the odd-numbered common electrodes being less than the high level voltage, gradation voltages applied to the pixel electrodes corresponding to the even-numbered common electrodes being greater than the low level voltage;
scanning the second gate line, applying the low level voltage to the odd-numbered common electrodes, applying the high level voltage to the even-numbered common electrodes, applying gradation voltages to the pixel electrodes, gradation voltages applied to the pixel electrodes corresponding to the odd-numbered common electrodes being greater than the low level voltage, gradation voltages applied to the pixel electrodes corresponding to the even-numbered common electrodes being less than the high level voltage;
scanning other gate lines according to above principle to display one frame image.

10. The method as claimed in claim 9, further comprising:
during the next frame, scanning the first gate line, applying the low level voltage to the odd-numbered common electrodes, applying the high level voltage to the even-numbered common electrodes, applying gradation voltages to the pixel electrodes, gradation voltages applied to the pixel electrodes corresponding to the odd-numbered common electrodes being greater than the low level voltage, gradation voltages applied to the pixel electrodes corresponding to the even-numbered common electrodes being less than the high level voltage;
scanning the second gate line, applying the low level voltage to the odd-numbered common electrodes, applying the high level voltage to the even-numbered common electrodes, applying gradation voltages to the pixel electrodes, gradation voltages applied to the pixel electrodes corresponding to the odd-numbered common electrodes being less than the high level voltage, gradation voltages applied to the pixel electrodes corresponding to the even-numbered common electrodes being greater than the low level voltage;
scanning other gate lines according to above principle to display one frame image.

11. The method as claimed in claim 8, wherein values of the gradation voltages are between the high level voltage and the low level voltage.

12. The method as claimed in claim 6, wherein an amplitude of the first alternating common voltage is equal to that of the second alternating common voltage.

13. The method as claimed in claim 6, wherein a frequency of the first alternating common voltage and the second alternating common voltage is the same as that of the scanning frequency of the gate lines.

14. The method as claimed in claim 13, wherein the frequency of the first alternating common voltage and the second alternating common voltage is 60 Hz.

15. A method for driving a liquid crystal display (LCD), the LCD comprising: a first substrate comprising a plurality of separated common electrodes; the method comprising: providing a first alternating common voltage to the odd-numbered common electrodes, and providing a second alternating common voltage to the even-numbered common electrodes, the first alternating common voltage having a reversed phase relative to the second alternating common voltage, both the phases of the first and second alternating common voltages being reversed after one gate line being scanned.

16. The method as claimed in claim 15, wherein the alternating common voltages have a high level voltage and a low level voltage.

17. The method as claimed in claim 16, wherein when the alternating common voltage is in the high level voltage, a gradation voltage less than the high level voltage is applied to the corresponding pixel electrodes.

18. The method as claimed in claim 17, wherein when the alternating common voltage is in the low level voltage, a gradation voltage greater than the low level voltage is applied to the corresponding pixel electrodes.
